(19) United States
(12) Patent Application Publication
(10) Pub. No.: US 2011/0021736 A1
(43) Pub. Date: Jan. 27, 2011

(54) Polyborosiloxane and Method of Preparing Same

(76) Inventor: Bizhong Zhu, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 12/867,896

(22) PCT Filed: Mar. 4, 2008
(86) PCT No.: PCT/US2009/034815

§ 371 Date: Sep. 17, 2010

Related U.S. Application Data
(60) Provisional application No. 61/033,442, filed on Mar. 4, 2008.

(51) Int. Cl. C08G 79/08

(52) U.S. Cl. 528/8

(57) ABSTRACT

A polyborosiloxane having a low content of boron-bonded hydroxy groups; and a method of preparing the polyborosiloxane.

### CROSS-REFERENCE TO RELATED APPLICATIONS

This application claims the benefit of U.S. Provisional Patent Application Ser. No. 61/033,442, filed on 4 Mar. 2008, under 35 U.S.C. §119(e). U.S. Provisional Patent Application Ser. No. 61/033,442 is hereby incorporated by reference.

### FIELD OF THE INVENTION

The present invention relates to a polyborosiloxane and more particularly to a polyborosiloxane having a low content of boron-bonded hydroxy groups. The present invention also relates to a method of preparing the polyborosiloxane.

### BACKGROUND OF THE INVENTION

Borosiloxanes and methods for their preparation are known in the art. For example, U.S. Pat. No. 5,112,779 to Burns et al. discloses the preparation of highly densified ceramic bodies by the pyrolysis of a mixture comprising a preceramic borosiloxane, silicon carbide powder, a curing agent for the borosiloxane, a crosslinking agent for the borosiloxane and, optionally, additional components to facilitate sintering.

U.S. Pat. No. 4,152,509 to Yajima et al. discloses borosiloxane polymers produced by heating at least one of a boric acid compound with phenylsilane to effect polycondensation reaction.

U.S. Pat. No. 4,248,814 to Yajimi et al. discloses a process for producing a heat-resistant ceramic sintered body, which comprises preparing polycarbosilane partly containing siloxane bonds by adding 0.01 to 15% by weight of polyborosiloxane containing phenyl groups in at least a part of the side chains of Si and having a skeletal structure composed of B, Si and O to a polysilane having the structure —(R¹R²Si)ₙ— wherein n is at least 3, and R¹ and R², independently from each other, represent methyl, ethyl, phenyl or hydrogen, and heating the polymer mixture in an atmosphere inert to the reaction thereby polymerizing it; mixing said polycarbosilane with a ceramic powder composed of at least one member selected from the group consisting of oxides, carbides, nitrides, borides and silicides; shaping the resulting mixture; and simultaneously with, or after, the shaping of the mixture, sintering the mixture at a temperature of from 800° C. to 2,000° C. in vacuum or in an atmosphere composed of at least one gas selected from the group consisting of inert gases, carbon monoxide gas, carbon dioxide gas, hydrogen gas, nitrogen gas and hydrocarbon gases.

U.S. Pat. No. 6,180,809 B1 to Pillot et al. discloses a boron and silicon oxynitride obtained by preparing a polyborosiloxane precursor, conducting nitriding pyrolysis of the precursor to obtain an amorphous boron and silicon oxynitride, and optionally conducting additional pyrolysis to obtain a crystallized boron and silicon oxynitride. The polyborosiloxane precursor is prepared by condensation, in the presence of a catalyst, of a polychlorosilane represented by the formula R³R⁴SiCl₂ in which the substituents R³ and R⁴ are identical or different and each represents a hydrogen atom, a chlorine atom, a linear or branched alkyl or alkenyl or alkynyl radical having 5 or less carbon atoms, or an aryl or aralkyl radical having 6 to 18 carbon atoms, with an alkyl borate represented by the formula (R⁵O)₃B in which R⁵ represents a linear or branched alkyl radical having 1 to 5 carbon atoms.

Although the aforementioned references disclose various borosiloxanes, they do not disclose the polyborosiloxane of the present invention having a low content of boron-bonded hydroxy groups or the method of preparing the polyborosiloxane.

### SUMMARY OF THE INVENTION

The present invention is directed to a polyborosiloxane having the formula:

(R¹₂BO_{1/2})ₗ[(BO_{(3-v)/2})(OH)ᵥ]ₘ[(R¹BO_{(2-w)/2})(OH)_{w}]ₙ(R¹₃SiO_{1/2})ₚ[(R¹₂SiO_{(2-x)/2})(OH)ₓ]_{q}[(R¹SiO_{(3-y)/2})(OH)_{y}]ᵣ[(SiO_{(4-z)/2})(OH)_{z}]ₛ (I)

wherein each R¹ is independently C₁ to C₁₀ hydrocarbyl or C₁ to C₁₀ halogen-substituted hydrocarbyl; 1 is from 0 to 0.2; m is from 0 to 0.5; n is from 0 to 0.6; p is from 0 to 0.7; q is from 0 to 0.9; r is from 0 to 0.999; s is from 0 to 0.5; v is from 0 to 0.05; w is from 0 to 0.05; x is from 0 to 0.45; y is from 0 to 0.63; z is from 0 to 0.25; m+n is from 0.001 to 0.58; q+r+s is from 0.42 to 0.999; (p+2q+3r+4s)/(3 m+2n) is from 1.01 to 1000; and l+m+n+p+q+r+s≈1.

The present invention is also directed to a method of preparing a polyborosiloxane, the method comprising:

(I) reacting (a) an alkoxyborane selected from (i) at least one trialkoxyborane having the formula B(OR²)₃, (ii) at least one dialkoxyborane having the formula R¹B(OR²)₂, (iii) a mixture comprising (a)(i) and (a)(ii), and (iv) a mixture comprising a monoalkoxyborane having the formula R¹₂BOR² and at least one of (a)(i) and (a)(ii), with (b) a halosilane selected from (i) at least one trihalosilane having the formula R′SiX₃, (ii) at least one dihalosilane having the formula R¹₂SiX₂, (iii) at least one tetrahalosilane having the formula SiX₄, (iv) a mixture comprising at least two of (b)(i), (b)(ii), and (b)(iii), and (v) a mixture comprising a monohalosilane having the formula R¹₃SiX and at least one of (b)(i), (b)(ii), and (b)(iii), in the presence of a Lewis acid catalyst to form a polyborosiloxane intermediate, wherein each R¹ is independently C₁ to C₁₀ hydrocarbyl or C₁ to C₁₀ halogen-substituted hydrocarbyl, R² is C₁ to C₈ alkyl, X is —Cl or —Br, the ratio of the sum of the number of moles of (a)(i) and (a)(ii) to the sum of the number of moles of the alkoxyborane (a) and the halosilane (b) is from 0.001 to 0.58, the ratio of the sum of the number of moles of (b)(i), (b)(ii), and (b)(iii) to the sum of the number of moles of the alkoxyborane (a) and the halosilane (b) is from 0.42 to 0.999, the ratio of the number of moles of the halosilane (b) to the number of moles of the alkoxyborane (a) is from 0.724 to 999, and the ratio of the number of moles of the group —X in the halosilane (b) to the number of moles of the group —OR² in the alkoxyborane (a) is at least 1.01;

(II) reacting the polyborosiloxane intermediate and, optionally, at least one halosilane having the formula R¹ₙSiX₄₋ₙ, with water to form a water-insoluble hydrolysis product, wherein R¹ and X are as defined above and n=0, 1, 2, or 3, provided when an excess amount of water is used, the method further comprises separating the hydrolysis product from the water; and

(III) distilling the hydrolysis product to remove water of condensation.

The polyborosiloxane has high transparency and good solubility in many organic solvents. Moreover, the polyborosiloxane has a very low content of boron-bonded hydroxy groups compared to polyborosiloxanes prepared by conventional methods, such as co-hydrolysis of boric acid or esters with siloxanes and/or alkoxysilanes. As a result, the polyborosiloxane is hydrolytically stable (i.e., resistant to degradation by moisture) and maintains high transparency after prolonged exposure to air.

The polyborosiloxane of the present invention can be thermally cured to form an adhesive coating between substrates. Also, when the polyborosiloxane contains silicon-bonded alkenyl groups, the polyborosiloxane can be combined with a cross-linking agent having silicon-bonded hydrogen atoms and a hydrosilylation catalyst to form a hydrosilylation-curable composition. The composition can also be thermally cured to form an adhesive coating between substrates.

These and other features, aspects, and advantages of the present invention will become better understood with reference to the following description and appended claims.

### DETAILED DESCRIPTION OF THE INVENTION

As used herein, the notation (BO_{(3-v)/2})(OH)ᵥ, and (R¹BO_{(2-w)/2})(OH)_{w} denote the average formulae of units having boron bonded to three oxygen atoms and two oxygen atoms, respectively, where each oxygen atom is also bonded to another atom, namely, Si or H. For example, a single unit having the formula (BO_{(3-v/2})(OH)ᵥ wherein v=0, can be represented by the structural formula:

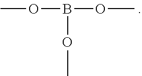

Similarly, a single unit having the formula (R¹BO_{(2-w)/2})(OH)_{w} wherein R¹ is C₁ to C₁₀ hydrocarbyl or C₁ to C₁₀ halogen-substituted hydrocarbyl and w=0, can be represented by the structural formula:

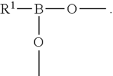

Furthermore, a unit having the formula R¹₂BO_{1/2}, wherein each R¹ is independently C₁ to C₁₀ hydrocarbyl or C₁ to C₁₀ halogen-substituted hydrocarbyl, has the formula.

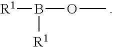

In each of the preceding formulas, the line segments attached to oxygen atoms represent free valences, i.e., points of attachment to other atoms.

A polyborosiloxane according to the present invention has the formula:

(R¹₂BO_{1/2})ₗ[(BO_{(3-v)/2})(OH)ᵥ]ₘ[(R¹BO_{(2-w)/2})(OH)_{w}]ₙ(R¹₃SiO_{1/2})ₚ[(R¹₂SiO_{(2-x)/2})(OH)ₓ]_{q}[(R¹SiO_{(3-y)/2})(OH)_{y}]ᵣ[(SiO_{(4-z)/2})(OH)_{z}]ₛ (I)

wherein each R¹ is independently C₁ to C₁₀ hydrocarbyl or C₁ to C₁₀ halogen-substituted hydrocarbyl; 1 is from 0 to 0.2; m is from 0 to 0.5; n is from 0 to 0.6; p is from 0 to 0.7; q is from 0 to 0.9; r is from 0 to 0.999; s is from to 0.5; v is from 0 to 0.05; w is from 0 to 0.05; x is from 0 to 0.45; y is from 0 to 0.63; z is from 0 to 0.25; m+n is from 0.001 to 0.58; q+r+s is from 0.42 to 0.999; (p+2q+3r+4s)/(3 m+2n) is from 1.01 to 1000; and l+m+n+p+q+r+s≈1.

The polyborosiloxane contains units having the formula [(BO_{(3-v)/2})(OH)ᵥ] and/or units having the formula [(R¹BO_{(2-w)/2})(OH)_{w}] in combination with at least one of the following: units having the formula [(R¹₂SiO_{(2-x)/2})(OH)ₓ], units having the formula [(R¹SiO_{(3-y)/2})(OH)_{y}], and units having the formula [(SiO_{(4-z)/2})(OH)_{z}], wherein R¹, v, w, x, y, and z are as defined and exemplified below.

The hydrocarbyl and halogen-substituted hydrocarbyl groups represented by R¹-typically have from 1 to 10 carbon atoms, alternatively from 1 to 6 carbon atoms, alternatively from 1 to 4 carbon atoms. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and naphthyl; alkaryl, such as tolyl and xylyl; aralkyl, such as benzyl and phenethyl; alkenyl, such as vinyl, allyl, and propenyl, butenyl, hexenyl, and octenyl; arylalkenyl, such as styryl and cinnamyl; and alkynyl, such as ethynyl and propynyl. Examples of halogen-substituted hydrocarbyl groups represented by R¹ include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

In one embodiment, the hydrocarbyl groups represented by R¹ in the formula (I) of the polyborosiloxane are not phenyl.

In the formula (I) of the polyborosiloxane, the subscripts l, m, n, p, q, r, and s are mole fractions. The subscript 1 typically has a value of from 0 to 0.2, alternatively from 0 to 0.1, alternatively from 0 to 0.05; the subscript m typically has a value of from 0 to 0.5, alternatively from 0.1 to 0.4, alternatively from 0.15 to 0.3; the subscript n typically has a value of from 0 to 0.6, alternatively from 0 to 0.4, alternatively from 0.1 to 0.2; the subscript p typically has a value of from 0 to 0.7, alternatively from 0 to 0.5, alternatively from 0 to 0.2; the subscript q typically has a value of from 0 to 0.9, alternatively from 0 to 0.7, alternatively from 0 to 0.5; the subscript r typically has a value of from 0 to 0.999, alternatively from 0 to 0.8, alternatively from 0.1 to 0.4; and the subscript s typically has a value of from 0 to 0.5, alternatively from 0 to 0.35, alternatively from 0.05 to 0.2. Also, the sum m+n is typically from 0.001 to 0.58, alternatively from 0.01 to 0.4, alternatively from 0.1 to 0.3; the sum q+r+s is typically from 0.42 to 0.999, alternatively from 0.45 to 0.9, alternatively from 0.6 to 0.8; and the ratio (p+2q+3r+4s)/(3 m+2n) is typically from 1.01 to 1000, alternatively from 1.2 to 100, alternatively from 1.5 to 10.

Also, in the formula (I) of the polyborosiloxane, the subscripts v, w, x, y and z represent the average numbers of hydroxy groups associated with the various units in the formula. The subscript v typically has a value of from 0 to 0.05, alternatively from 0 to 0.04, alternatively from 0 to 0.03; the subscript w typically has a value of from 0 to 0.05, alternatively from 0.01 to 0.04, alternatively from 0.01 to 0.02; the subscript x typically has a value of from 0 to 0.45, alternatively from 0.01 to 0.35, alternatively from 0.05 to 0.25; the subscript y typically has a value of from 0 to 0.63, alternatively from 0.01 to 0.4, alternatively from 0.05 to 0.25; the subscript z typically has a value of from 0 to 0.25, alternatively from 0.01 to 0.15, alternatively from 0.01 to 0.05.

Furthermore, in the formula (I) of the polyborosiloxane, the sum l+m+n+p+q+r+s≈ (is approximately equal to) 1. This means that in addition to units having the average formulas shown in the formula (I) above, the polyborosiloxane may contain residual amounts, e.g., not greater than 5 mol %, of one or more units having the following average formulas: and (SiO_{(4-z′/2})(X)_{z′}, wherein R¹ is as defined and exemplified above, R² is C₁ to C₈ alkyl, X is —Cl or —Br, v′ has an average value of from 0 to 0.04; w′ has an average value of from 0 to 0.02; x′ has an average value of from 0 to 0.03; y′ has an average value of from 0 to 0.03; and z′ has an average value of from 0 to 0.03.

The alkyl groups represented by R² typically have from 1 to 8 carbon atoms, alternatively from 1 to 6 carbon atoms, alternatively from 1 to 4 carbon atoms. Acyclic alkyl groups containing at least 3 carbon atoms can have a branched or unbranched structure. Examples of alkyl groups represented by R² include, but are not limited to, methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, and octyl; and cycloalkyl, such as cyclopentyl, cyclohexyl, and methylcyclohexyl.

In one embodiment, the polyborosiloxane has an average of at least two alkenyl groups per molecule. The alkenyl groups, represented by R¹ can be bonded to boron atoms, silicon atoms, or both boron and silicon atoms. In this embodiment, typically at least 10 mol %, alternatively at least 25 mol %, alternatively at least 50 mol % of the groups R¹ in the polyborosiloxane are alkenyl. As used herein, the term “mol % of the groups R¹ in the polyborosiloxane are alkenyl” is defined as the ratio of the number of moles of silicon-bonded and boron-bonded alkenyl groups in the polyborosiloxane to the total number of moles of the groups R¹ in the polyborosiloxane, multiplied by 100.

The polyborosiloxane typically has a number-average molecular weight (Mₙ) of from 500 to 1,000,000, alternatively from 500 to 500,000, alternatively 10,000 to 500,000, alternatively from 10,000 to 50,000, where the molecular weight is determined by gel permeation chromatography employing a refractive index detector and silicone resin (MQ) standards.

The viscosity of the polyborosiloxane at 25° C. is typically from 0.5 to 10,000 Pa·s, alternatively from 1 to 1,000 Pa·s, alternatively from 2 to 100 Pa·s.

The polyborosiloxane typically contains less than 20% (w/w), alternatively less than 15% (w/w), alternatively less than 10% (w/w), of silicon-bonded hydroxy groups, as determined by ²⁹Si NMR.

Also, the polyborosiloxane typically contains less than 5 mol %, alternatively less than 4 mol %, alternatively less than 3 mol %, of boron-bonded hydroxy groups, where the mol % of boron-bonded hydroxy groups is defined as the ratio of the number of moles of boron-bonded hydroxy groups in the polyborosiloxane to the sum of the number of moles of Si atoms and B atoms in the polyborosiloxane, multiplied by 100. Moreover, the mol % of boron-bonded hydroxy groups can be estimated from the relation: D=vBC/A, where D is mol % of boron-bonded hydroxy groups; v is a proportionality constant, which is assumed to have a value of 1; A is the area of the Si—OH absorption centered at approximately ˜3400 cm⁻¹ in the FTIR spectrum of the polyborosiloxane; B is the area of the B—OH absorption centered at approximately ˜3230 cm⁻¹ in the FTIR spectrum of the polyborosiloxane; and C is mol % of silicon-bonded hydroxy groups in the polyborosiloxane, as determined by ²⁹Si NMR.

The polyborosiloxane of the present invention is soluble in a variety of organic solvents. For example, the solubility of the polyborosiloxane in an organic solvent, which depends on the structure, molecular weight, and content of silicon-bonded hydroxy groups, is typically at least 2 g/mL, alternatively at least 1 g/mL, at room temperature (˜23±2° C.). In particular, the solubility of the polyborosiloxane in methyl isobutyl ketone is typically from 0.1 to 2 g/mL, alternatively from 0.2 to 1 g/mL, at room temperature (˜23±2° C.).

The polyborosiloxane typically exhibits high transparency. Generally, the transparency of the polyborosiloxane depends on the composition of the polyborosiloxane and the thickness of the sample. For example, a film of the polyborosiloxane having a thickness of 50 μm typically has a percent transmittance of at least 80%, alternatively at least 85%, alternatively at least 90%, for light in the visible region (˜400 to ˜700 nm) of the electromagnetic spectrum. In particular, the polyborosiloxane exhibits high transparency even after exposure to air for prolonged periods of time, e.g., several days to several months.

Examples of polyborosiloxanes having the formula (I) include, but are not limited to, polyborosiloxanes having the following formulae:

(ViMe₂SiO_{1/2})_{0.7}(BO_{3/2})_{0.25}(SiO_{4/2})_{0.05},

(BO_{3/2})_{0.15}(Me₂SiO_{2/2})_{0.55}(PhSiO_{3/2})_{0.30},

(BO_{3/2})_{0.1}(PhBO_{2/2})_{0.25}(ViMe₂SiO_{1/2})_{0.25}(MeSiO_{3/2})_{0.4},

(BO_{3/2})_{0.25}(BO_{2/2}(OH))_{0.05}(Me₂SiO_{2/2})_{0.6}(Me₂SiO_{1/2}(OH))_{0.1},

(PhBO_{2/2})_{0.15}(PhBO_{1/2}(OH))_{0.03}(PhSiO_{3/2})_{0.31}(PhSiO_{2/2}(OH))_{0.51},

(ViMeBO_{1/2})_{0.05}(BO_{3/2})_{0.2}(ViMe₂SiO_{1/2})_{0.1}(MeSiO_{3/2})_{0.65},

(BO_{3/2})_{0.01}(Me₂SiO_{2/2})_{0.4}(Me₂SiO_{1/2}(OH))_{0.05}(PhSiO_{2/2}(OH))_{0.54}, and

(PhBO_{2/2})_{0.3}(MeSiO_{3/2})_{0.6}(ViMe₂SiO_{1/2})_{0.1},

where Me is methyl, Vi is vinyl, Ph is phenyl, and the numerical subscripts outside the parentheses denote mole fractions. Also, in the preceding formulae, the sequence of units is unspecified.

The polyborosiloxane of the present invention can be prepared by (I) reacting (a) an alkoxyborane selected from (i) at least one trialkoxyborane having the formula B(OR²)₃, (ii) at least one dialkoxyborane having the formula R¹B(OR²)₂, (iii) a mixture comprising (a)(i) and (a)(ii), and (iv) a mixture comprising a monoalkoxyborane having the formula R¹₂BOR² and at least one of (a)(i) and (a)(ii), with (b) a halosilane selected from (i) at least one trihalosilane having the formula R¹SiX₃, (ii) at least one dihalosilane having the formula R¹₂SiX₂, (iii) at least one tetrahalosilane having the formula SiX₄, (iv) a mixture comprising at least two of (b)(i), (b)(ii), and (b)(iii), and (v) a mixture comprising a monohalosilane having the formula R¹₃SiX and at least one of (b)(i), (b)(ii), and (b)(iii), in the presence of a Lewis acid catalyst to form a polyborosiloxane intermediate, wherein each R¹ is independently C₁ to C₁₀ hydrocarbyl or C₁ to C₁₀ halogen-substituted hydrocarbyl, R² is C₁ to C₈ alkyl, X is —Cl or —Br, the ratio of the sum of the number of moles of (a)(i) and (a)(ii) to the sum of the number of moles of the alkoxyborane (a) and the halosilane (b) is from 0.001 to 0.58, the ratio of the sum of the number of moles of (b)(i), (b)(ii), and (b)(iii) to the sum of the number of moles of the alkoxyborane (a) and the halosilane (b) is from 0.42 to 0.999, the ratio of the number of moles of the halosilane (b) to the number of moles of the alkoxyborane (a) is from 0.724 to 999, and the ratio of the number of moles of the group —X in the halosilane (b) to the number of moles of the group —OR² in the alkoxyborane (a) is at least 1.01; (II) reacting the polyborosiloxane intermediate and, optionally, at least one halosilane having the formula R¹ₙSiX₄₋ₙ, with water to form a water-insoluble hydrolysis product, wherein R¹ and X are as defined above and n=0, 1, 2, or 3, provided when an excess amount of water is used, the method further comprises separating the hydrolysis product from the water; and (III) distilling the hydrolysis product to remove water of condensation.

In step (I) of the method of preparing the polyborosiloxane, (a) an alkoxyborane selected from (i) at least one trialkoxyborane having the formula B(OR²)₃, (ii) at least one dialkoxyborane having the formula R¹B(OR²)₂, (iii) a mixture comprising (a)(i) and (a)(ii), and (iv) a mixture comprising a monoalkoxyborane having the formula R¹₂BOR² and at least one of (a)(i) and (a)(ii), is reacted with (b) a halosilane selected from (i) at least one trihalosilane having the formula R′SiX₃, (ii) at least one dihalosilane having the formula R¹₂SiX₂, (iii) at least one tetrahalosilane having the formula SiX₄, (iv) a mixture comprising at least two of (b)(i), (b)(ii), and (b)(iii), and (v) a mixture comprising a monohalosilane having the formula R¹₃SiX and at least one of (b)(i), (b)(ii), and (b)(iii), in the presence of a Lewis acid catalyst to form a polyborosiloxane intermediate, wherein each R¹ is independently C₁ to C₁₀ hydrocarbyl or C₁ to C₁₀ halogen-substituted hydrocarbyl, R² is C₁ to C₈ alkyl, X is —Cl or —Br, the ratio of the sum of the number of moles of (a)(i) and (a)(ii) to the sum of the number of moles of the alkoxyborane (a) and the halosilane (b) is from 0.001 to 0.58, the ratio of the sum of the number of moles of (b)(i), (b)(ii), and (b)(iii) to the sum of the number of moles of the alkoxyborane (a) and the halosilane (b) is from 0.42 to 0.999, the ratio of the number of moles of the halosilane (b) to the number of moles of the alkoxyborane (a) is from 0.724 to 999, and the ratio of the number of moles of the group —X in the halosilane (b) to the number of moles of the group —OR² in the alkoxyborane (a) is at least 1.01.

Alkoxyborane (a) is selected from (i) at least one trialkoxyborane having the formula B(OR²)₃, (ii) at least one dialkoxyborane having the formula R¹B(OR²)₂, (iii) a mixture comprising (a)(i) and (a)(ii), and (iv) a mixture comprising a monoalkoxyborane having the formula R¹₂BOR² and at least one of (a)(i) and (a)(ii), wherein R¹ and R² are as defined and exemplified above.

Alkoxyborane (a)(i) at least one trialkoxyborane having the formula B(OR²)₃, wherein R² is as described and exemplified above. Examples of trialkoxyboranes include, but are not limited to, trimethyl borate, triethyl borate, tripropyl borate, tripentyl borate, trihexyl borate, and trioctyl borate.

Alkoxyborane (a)(i) can be a single trialkoxyborane or a mixture comprising two or more different trialkoxyboranes, each having the formula B(OR²)₃ wherein R² is as defined and exemplified above. Methods of preparing trialkoxyboranes are well known in the art; many of these compounds are commercially available.

Alkoxyborane (a)(ii) is at least one dialkoxyborane having the formula R¹B(OR²)₂, wherein R¹ and R² are as defined and exemplified above. Examples of dialkoxyboranes include, but are not limited to, phenyldimethoxyborane, methyldimethoxyborane, phenyldiethoxyborane, methyldiethoxyborane, and n-butyldimethoxyborane.

Alkoxyborane (a)(ii) can be a single dialkoxyborane or a mixture comprising two or more different dialkoxyboranes, each having the formula R¹B(OR²)₂ wherein R¹ and R² are as defined and exemplified above. Methods of preparing dialkoxyboranes are well known in the art; many of these compounds are commercially available.

Alkoxyborane (a)(iii) is a mixture comprising (a)(i) and (a)(ii), each as described above.

Alkoxyborane (a)(iv) is a mixture comprising a monoalkoxyborane having the formula R¹₂BOR² and at least one of (a)(i) and (a)(ii), wherein R¹ and R² are as defined and exemplified above. Examples of monoalkoxyboranes include, but are not limited to, methylphenylmethoxyborane and dimethylmethoxyborane.

The monoalkoxyborane can be a single monoalkoxyborane or a mixture comprising two or more different monoalkoxyboranes, each having the formula R¹₂BOR², wherein R¹ and R² are as defined and exemplified above. Methods of preparing monoalkoxyboranes are well known in the art; many of these compounds are commercially available.

Halosilane (b) is selected from (i) at least one trihalosilane having the formula R¹SiX₃, (ii) at least one dihalosilane having the formula R¹₂SiX₂, (iii) at least one tetrahalosilane having the formula SiX₄, (iv) a mixture comprising at least two of (b)(i), (b)(ii), and (b)(iii), and (v) a mixture comprising a monohalosilane having the formula R¹₃SiX and at least one of (b)(i), (b)(ii), and (b)(iii), wherein R¹ is C₁ to C₁₀ hydrocarbyl or C₁ to C₁₀ halogen-substituted hydrocarbyl, and X is —Cl or —Br.

Halosilane (b)(i) is at least one trihalosilane having the formula R′SiX₃, wherein R¹ and X are as described and exemplified above. Examples of trihalosilanes include, but are not limited to, silanes having the formulae: MeSiCl₃, EtSiCl₃, MeSiBr₃, EtSiBr₃, PhSiCl₃, n-BuSiCl₃, and i-PrSiCl₃, where Me is methyl, Et is ethyl, Ph is phenyl, n-Bu is normal butyl, and i-Pr is isopropyl.

Halosilane (b)(i) can be a single trihalosilane or a mixture comprising two or more different trihalosilanes, each having the formula R¹SiX₃ wherein R¹ and X are as defined and exemplified above. Methods of preparing trihalosilanes are well known in the art; many of these compounds are commercially available.

Halosilane (b)(ii) is at least one dihalosilane having the formula R¹₂SiX₂, wherein R¹ and X are as defined and exemplified above. Examples of dihalosilanes include, but are not limited to, silanes having the formulae: Me₂SiCl₂, Et₂SiCl₂, Me₂SiBr₂, Et₂SiBr₂, PhMeSiCl₂, ViMeSiCl₂, and Ph₂SiCl₂, where Me is methyl, Et is ethyl, Ph is phenyl, and Vi is vinyl.

Halosilane (b)(ii) can be a single dihalosilane or a mixture comprising two or more different dihalosilanes, each having the formula R¹₂SiX₂, wherein R¹ and X are as defined and exemplified above. Methods of preparing dihalosilanes are well known in the art; many of these compounds are commercially available.

Halosilane (b)(iii) is at least one tetrahalosilane having the formula SiX₄, wherein X is —Cl or —Br. Examples of tetrahalosilanes include SiCl₄ and SiBr₄.

Halosilane (b)(iii) can be a single tetrahalosilane or a mixture comprising two or more different tetrahalosilanes, each having the formula SiX₄, wherein X is as defined and exemplified above. Methods of preparing tetrahalosilanes are well known in the art; many of these compounds are commercially available.

Halosilane (b)(iv) is a mixture comprising at least two of (b)(i), (b)(ii), and (b)(iii), each as described above.

Halosilane (b)(v) is a mixture comprising a monohalosilane having the formula R¹₃SiX and at least one of (b)(i), (b)(ii), and (b)(iii), wherein R¹ and X are as defined and exemplified above. Examples of monohalosilanes include, but are not limited to, silanes having the formulae: ViMe₂SiCl, ViPhMeSiCl, Me₃SiBr, PhMe₂SiCl, Vi₂MeSiBr, and Ph₂MeSiCl, wherein Me is methyl, Vi is vinyl, and Ph is phenyl.

The monohalosilane can be a single monohalosilane or a mixture comprising two or more different monohalosilanes, each having the formula R¹₃SiX, wherein R¹ and X are as defined and exemplified above. Methods of preparing monohalosilanes are well known in the art; many of these compounds are commercially available.

The Lewis acid catalyst is at least one Lewis acid catalyst capable of promoting a condensation reaction between the boron-bonded groups —OR² in the alkoxyborane (a) and the silicon-bonded groups —X in the halosilane (b). Examples of Lewis acid catalysts include, but are not limited to, catalysts having the following formulae: AlCl₃, FeCl₃, BCl₃, and ZnCl₂. The Lewis acid catalyst can be a single Lewis acid catalyst or a mixture comprising two or more different Lewis acid catalysts.

The reaction of the alkoxyborane with the halosilane to produce the polyborosiloxane intermediate can be carried out in any standard reactor suitable for contacting, for example, halosilanes with alkoxyboranes. Suitable reactors include glass and Teflon-lined glass reactors. Preferably, the reactor is equipped with a means of agitation, such as stirring. Also, preferably, the reaction is carried out in an inert atmosphere, such as nitrogen or argon, in the absence of moisture.

Alkoxyborane (a) is typically added to a mixture of the halosilane (b) and the Lewis acid catalyst. Reverse addition, i.e., addition of the halosilane to the alkoxyborane in the presence of the Lewis acid catalyst, is also possible. However, reverse addition may lead to a polyborosiloxane having higher polydispersity and, in some cases, may cause gel formation.

The rate of addition of the alkoxyborane (a) to the mixture of the halosilane (b) and the Lewis acid catalyst is typically from 0.1 to 2 mL/min. for a 1000-mL reaction vessel equipped with an efficient means of stirring. When the rate of addition is too slow, the reaction time is unnecessarily prolonged. When the rate of addition is too fast, the reaction mixture may form a gel.

The reaction of the alkoxyborane (a) with the halosilane (b) is typically carried out at a temperature of from 25 to 150° C., alternatively from 30 to 90° C., alternatively from 40 to 80° C. When the temperature is less than 25° C., the rate of the reaction is typically very slow. When the temperature is greater than 150° C., excessive volatilization of the reactants occurs.

The reaction time depends on several factors, including the structures of the alkoxyborane (a) and the halosilane (b), and the temperature. The reaction is typically carried out for an amount of time sufficient to convert at least 95 mol % of the groups —OR² originally present in the alkoxyborane to —O—Si linkages. For example, the reaction time is typically from 1 to 24 h, alternatively from 1 to 8 h, alternatively from 2 to 5 h, at a temperature of from 40 to 80° C. The optimum reaction time can be determined by routine experimentation using the methods set forth in the Examples section below.

The ratio of the sum of the number of moles of (a)(i) and (a)(ii) to the sum of the number of moles of the alkoxyborane (a) and the halosilane (b) is typically from 0.001 to 0.58, alternatively from 0.01 to 0.4, alternatively from 0.1 to 0.35.

The ratio of the sum of the number of moles of (b)(i), (b)(ii), and (b)(iii) to the sum of the number of moles of the alkoxyborane (a) and the halosilane (b) is typically from 0.42 to 0.999, alternatively from 0.5 to 0.9, alternatively from 0.6 to 0.8.

The ratio of the number of moles of the halosilane (b) to the number of moles of the alkoxyborane (a) is typically from 0.724 to 999, alternatively from 1.2 to 99, alternatively from 1.5 to 9.

The ratio of the number of moles of the group —X in the halosilane (b) to the number of moles of the group —OR² in the alkoxyborane (a) is typically at least 1.01. For example, the ratio of the number of moles of the group —X in the halosilane (b) to the number of moles of the group —OR² in the alkoxyborane (a) is typically from 1.01 to 1,000, alternatively from 1.2 to 100, alternatively from 1.5 to 10.

The concentration of the Lewis acid catalyst is sufficient to catalyze the reaction of the alkoxyborane (a) with the halosilane (b). Typically, the concentration of the Lewis acid catalyst is from 0.1 to 3% (w/w), alternatively from 0.5 to 1% (w/w), based on the combined weight of the alkoxyborane and the halosilane.

In step (II) of the method of preparing the polyborosiloxane, the polyborosiloxane intermediate and, optionally, at least one halosilane having the formula R¹ₙSiX₄₋ₙ, are reacted with water to form a water-insoluble hydrolysis product, wherein R¹ and X are as defined above and n=0, 1, 2, or 3, provided when an excess amount of water is used, the method further comprises separating the hydrolysis product from the water.

The optional halosilane of step (II) is at least one halosilane having the formula R¹ₙSiX₄₋ₙ, wherein R¹ and X are as defined and exemplified above, and n is 0, 1, 2, or 3. Thus, the halosilane can be a monohalosilane having the formula R¹₃SiX, a dihalosilane having the formula R¹₂SiX₂, a trihalosilane having the formula R¹SiX₃, or a tetrahalosilane having the formula SiX₄, wherein R¹ and X are as defined and exemplified above. Examples of monohalosilanes, dihalosilanes, trihalosilanes, and tetrahalosilanes are as described above for step (I) of the present method. Moreover, the optional halosilane can be a single halosilane or a mixture comprising two or more different halosilanes, each having the formula R¹ₙSiX₄₋ₙ, wherein R¹ and X are as defined and exemplified above.

The polyborosiloxane intermediate and optional halosilane are typically combined with water by adding the intermediate to the water. Reverse addition, i.e., addition of water to the polyborosiloxane intermediate is also possible.

The rate of addition of the polyborosiloxane intermediate and optional halosilane to water is typically from 2 mL/min. to 1,000 mL/min. for a 1000-mL reaction vessel, preferably equipped with an efficient means of stirring. When the rate of addition is too slow, the reaction time is unnecessarily prolonged. When the rate of addition is too fast, the reaction mixture may form a gel.

The reaction of the borosiloxane intermediate with water is typically carried out at a temperature of from 0 to 50° C., alternatively from 0 to 30° C., alternatively from 2 to 10° C. When the temperature is less than 0° C., the rate of the reaction is typically very slow. When the temperature is greater than 50° C., the reaction mixture may form a gel.

The reaction time depends on several factors, including the structure of the polyborosiloxane intermediate and the temperature. The reaction is typically carried out for an amount of time sufficient to effect hydrolysis of the polyborosiloxane intermediate and any optional halosilane. As used herein, the term “hydrolysis” means that at least 95 mol % of the silicon-bonded groups —X originally present in the polyborosiloxane intermediate and any optional halosilane are converted to silicon-bonded hydroxy groups. For example, the reaction time is typically from 15 to 300 min., alternatively from 15 to 100 min., alternatively from 30 to 50 min., at a temperature of from 2 to 10° C. The optimum reaction time can be determined by routine experimentation using the methods set forth in the Examples section below.

The concentration of water in the reaction mixture is typically sufficient to effect hydrolysis of the polyborosiloxane intermediate and any optional halosilane. For example, the concentration of water is typically such that the ratio of the number of moles of water to the sum of the number of moles of the silicon-bonded groups —X in the polyborosiloxane intermediate and the optional halosilane is from 0.5 to 10, alternatively from 1 to 8, alternatively from 4 to 6.

The reaction of the polyborosiloxane intermediate and optional halosilane with water can also be carried out in the presence of an organic solvent. The organic solvent can be any aprotic or dipolar aprotic organic solvent that does not react with the polyborosiloxane intermediate and optional halosilane under the conditions of the present method, and is miscible with the polyborosiloxane intermediate and the hydrolysis product. The organic solvent is typically immiscible with water. As used herein, the term “immiscible” means that the solubility of water in the solvent is less than about 0.1 g/100 g of solvent at 25° C.

Examples of organic solvents include, but are not limited to, saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; and halogenated aromatic hydrocarbons such as bromobenzene and chlorobenzene.

The organic solvent can be a single organic solvent or a mixture comprising two or more different organic solvents, each as described and exemplified above.

When present, the concentration of the organic solvent is typically from 1 to 80% (w/w), alternatively from 5 to 60% (w/w), alternatively from 30 to 50% (w/w), based on the total weight of the reaction mixture.

When the polyborosiloxane intermediate and, optionally, the halosilane are reacted with an excess amount of water, the method typically further comprises separating the hydrolysis product from the water before proceeding to step (III), described below. As used herein, the term “excess amount of water” means the concentration of water is such that the ratio of the number of moles of water to the sum of the number of moles of the silicon-bonded group —X in the polyborosiloxane intermediate and the optional halosilane is typically greater than 1, for example from 1 to 8, alternatively from 4 to 6.

The hydrolysis product can be separated from the water by discontinuing agitation of the mixture, allowing the mixture to separate into two layers, an organic phase and an aqueous phase, and removing the organic phase containing the hydrolysis product. The organic phase is typically washed with water. The water can further comprise a neutral inorganic salt, such as sodium chloride, to minimize formation of an emulsion between the water and organic phase during washing. The concentration of the neutral inorganic salt in the water can be up to saturation. The organic phase can be washed by mixing it with water, allowing the mixture to separate into two layers, and removing the aqueous layer. The organic phase is typically washed from 1 to 5 times with separate portions of water. The volume of water per wash is typically from 0.5 to 2 times the volume of the organic phase. The mixing can be carried out by conventional methods, such as stirring or shaking.

In step (III) of the method of preparing the polyborosiloxane, the hydrolysis product is distilled to remove water of condensation, i.e., water formed by the condensation of silicon-bonded hydroxy groups in the hydrolysis product during heating. The distillation can be carried out at atmospheric or subatmospheric pressure. The distillation is typically carried out at a temperature of from 80 to 150° C., alternatively from 90 to 110° C., at 100 kPa. The distillation is typically continued for an amount of time sufficient to produce a polyborosiloxane having a number-average molecular weight of from 500 to 1000,000. For example, the hydrolysis product is typically heated at a temperature of from 80 to 149° C. for a period of from 0.5 to 24 h, alternatively at a temperature of from 90 to 120° C. for a period of from 1 to 12 h, alternatively at a temperature of from 100 to 115° C. for a period of from 3 to 8 h. When distillation is carried out in the presence of a condensation catalyst, described below, the polyborosiloxane can typically be formed at a lower temperature and/or in less time.

When the polyborosiloxane has a relatively high viscosity, for example, greater than 100 Pa·s at 25° C., the removal of water is facilitated by performing the distillation of the hydrolysis product in the presence of a water-immiscible organic solvent that forms a minimum boiling azeotrope with water. In this case, the distillation can be conveniently carried out using a Dean-Stark trap, which collects water and returns solvent to the distillation vessel.

The hydrolysis product can also be distilled in the presence of a condensation catalyst. The condensation catalyst can be any condensation catalyst typically used to promote condensation of silicon-bonded hydroxy (silanol) groups to form Si—O—Si linkages. Examples of condensation catalysts include, but are not limited to, tin(II) and tin(IV) compounds such as tin dilaurate, tin dioctoate, and tetrabutyl tin; zinc compounds such as zinc octoate; and titanium compounds such as titanium tetrabutoxide. The condensation catalyst can be a single condensation catalyst or a mixture comprising two or more different condensation catalysts.

When present, the concentration of the condensation catalyst is typically from 0.1 to 10% (w/w), alternatively from 0.5 to 5% (w/w), alternatively from 1 to 3% (w/w), based on the combined weight of the alkoxyborane and the halosilane used in step (I) of the method.

The condensation catalyst can be readily removed by filtering the mixture of the polyborosiloxane and condensation catalyst after distillation of the hydrolysis product.

According to one embodiment of the method of preparing the polyborosiloxane, the alkoxyborane (a), the halosilane (b), and the optional halosilane (step II) do not contain phenyl groups.

According to another embodiment of the method, at least 10 mol %, alternatively at least 25 mol %, alternatively at least 50 mol %, of the groups represented by R¹ in the alkoxyborane (a), the halosilane (b), and optional halosilane (step II) combined are alkenyl.

The polyborosiloxane has high transparency and good solubility in many organic solvents. Moreover, the polyborosiloxane has a very low content of boron-bonded hydroxy groups compared to polyborosiloxanes prepared by conventional methods, such as co-hydrolysis of boric acid or esters with siloxanes and/or alkoxysilanes. As a result, the polyborosiloxane is hydrolytically stable (i.e., resistant to degradation by moisture) and maintains high transparency after prolonged exposure to air.

The polyborosiloxane of the present invention can be thermally cured to form an adhesive coating between substrates. Also, when the polyborosiloxane contains silicon-bonded alkenyl groups, the polyborosiloxane can be combined with a cross-linking agent having silicon-bonded hydrogen atoms and a hydrosilylation catalyst to form a hydrosilylation-curable composition. The composition can also be thermally cured to form an adhesive coating between substrates.

### EXAMPLES

The following examples are presented to better illustrate the polyborosiloxane and method of the present invention, but are not to be considered as limiting the invention, which is delineated in the appended claims. Unless otherwise noted, all parts and percentages reported in the examples are by weight.

### Example 1

Iron(III) chloride was dried over a small amount of thionyl chloride overnight. Trimethyl borate was added drop-wise to a stirred mixture of 0.4 g of FeCl₃ and 60 g of dimethyldichlorosilane under nitrogen at 50° C. During the addition, volatile products were removed by distillation. After completion of the addition of trimethyl borate, the mixture was stirred at 50° C. for an additional 1 h. Then the temperature was raised to 80° C. and maintained at this temperature for 1 h. Heating was discontinued and the mixture was allowed to cool to room temperature to give a polyborosiloxane intermediate.

### Example 2

The polyborosiloxane intermediate of Example 1 (5 g) was combined with 5 g of dimethyldichlorosilane and 10 g of toluene. The mixture was poured into 50 g of de-ionized water and the resulting two-phase mixture was shaken vigorously. Agitation was discontinued and the organic and aqueous phases were allowed to separate. The upper organic phase was collected and washed with 20 g portions of de-ionized water several times. The mixture was transferred to a flask equipped with a Dean-Stark Trap and thermometer and distilled at 89 to 115° C. to remove water. When the volume of water collected remained constant, the mixture was allowed to cool to room temperature to give a polyborosiloxane.

A sample of the polyborosiloxane was placed in an aluminum dish and heated in an air-circulating oven at 200° C. for 1 h to give, upon cooling to room temperature, a cured polyborosiloxane as a transparent solid. After storage under ambient conditions for 4 h, the cured polyborosiloxane remained transparent. After storage overnight, the cured polyborosiloxane became slightly hazy. However, further storage did not produce a further change in transparency.

### Example 3

The polyborosiloxane intermediate of Example 1 (15 g) was combined with 30 g of dimethyldichlorosilane, 8 g of vinyldimethylchlorosilane, and 40 g of p-xylene. The mixture was poured into 40 g of de-ionized water and the resulting two-phase mixture was shaken vigorously. Agitation was discontinued and the organic and aqueous phases were allowed to separate. The upper organic phase was collected and washed with 40 g portions of de-ionized water several times, dried over 5 g of magnesium sulfate, and then filtered. The filtrate was treated with 0.2% (w/w) of zinc octoate, based on the theoretical yield of the polyborosiloxane, and the mixture was heated in a flask equipped with a Dean-Stark trap and a thermometer and distilled at 120° C. for 2 hours to remove water. The mixture was allowed to cool to room temperature and then filtered. The filtrate was concentrated under reduced pressure (5 mmHg, 667 Pa) at 80° C. using a rotary evaporator to give a polyborosiloxane as a viscous liquid.

### Comparative Example 1

A polyborosiloxane was prepared according to a well-known method in the art (e.g., see U.S. Pat. No. 5,112,779). 1,1,3,3-Tetramethyl-1,3-divinyldisiloxane (0.125 mol), 1.5 mol of deionized water, and 0.1 g of trifluoromethanesulfonic acid were combined in a three-neck flask equipped with a thermometer, a condenser, a mechanical stirrer, and a heating mantle. A mixture of 0.25 mol of trimethoxyphenylsilane, 0.25 mol of dimethyldimethoxysilane, and 0.25 mol of trimethyl borate was added drop-wise to the flask at room temperature with stirring. After completion of the addition, the mixture was heated to 60° C. and kept at this temperature for 1 h. The temperature of the mixture was then increased slowly to allow distillation of the methanol by-product. When the temperature of the mixture reached 85° C., heating was discontinued and the mixture was allowed to cool to room temperature. The mixture was then treated with 1 g of calcium carbonate and stirred for 1 h. The mixture was filtered through filter paper (5 μm pore size). The filtrate was diluted with toluene and then treated with 0.03% (w/w), based on the theoretical yield of the polyborosiloxane, of potassium hydroxide. The mixture was transferred to a flask equipped with a Dean-Stark Trap and thermometer and distilled at 110 to 115° C. to remove water. When the volume of water collected remained constant, the mixture was allowed to cool to room temperature. A sample of the mixture was placed in an aluminum dish and heated in an air-circulating oven at 150° C. for 1 h to give, upon cooling to room temperature, a highly viscous transparent liquid. After storage under ambient condition for 4 h, the polyborosiloxane became opaque.

That which is claimed is:

1. A polyborosiloxane having the formula:
(R¹₂BO_{1/2})ₗ[(BO_{(3-v)/2})(OH)ᵥ]ₘ[R¹BO_{(2-w)/2})(OH)_{w}]ₙ(R¹₃SiO_{1/2})ₚ[(R¹₂SiO_{(2-x)/2})(OH)ₓ]_{q}[(R¹SiO_{(3-y)/2})(OH)_{y}]ᵣ[(SiO_{(4-z)/2})(OH)_{z}]ₛ (I)
wherein each R¹ is independently C₁ to C₁₀ hydrocarbyl or C₁ to C₁₀ halogen-substituted hydrocarbyl; 1 is from 0 to 0.2; m is from 0 to 0.5; n is from 0 to 0.6; p is from 0 to 0.7; q is from 0 to 0.9; r is from 0 to 0.999; s is from to 0.5; v is from 0 to 0.05; w is from 0 to 0.05; x is from 0 to 0.45; y is from 0 to 0.63; z is from 0 to 0.25; m+n is from 0.001 to 0.58; q+r+s is from 0.42 to 0.999; (p+2q+3r+4s)/(3 m+2n) is from 1.01 to 1000; and l+m+n+p+q+r+s≈1.

2. The polyborosiloxane according to claim 1, wherein the hydrocarbyl groups represented by R¹ are not phenyl.

3. The polyborosiloxane according to claim 1, wherein the polyborosiloxane has an average of at least two alkenyl groups per molecule.

4. The polyborosiloxane according to claim 1, wherein at least 10 mol % of the groups R¹ in the polyborosiloxane are alkenyl.

5. The polyborosiloxane according to claim 1, wherein the polyborosiloxane contains less than 15% (w/w) of silicon-bonded hydroxy groups.

6. The polyborosiloxane according to claim 1, wherein the polyborosiloxane contains less than 5 mol % of boron-bonded hydroxy groups.

7. A method of preparing a polyborosiloxane, the method comprising:
(I) reacting (a) an alkoxyborane selected from (i) at least one trialkoxyborane having the formula B(OR²)₃, (ii) at least one dialkoxyborane having the formula R¹B(OR²)₂, (iii) a mixture comprising (a)(i) and (a)(ii), and (iv) a mixture comprising a monoalkoxyborane having the formula R¹₂BOR² and at least one of (a)(i) and (a)(ii), with (b) a halosilane selected from (i) at least one trihalosilane having the formula R¹SiX₃, (ii) at least one dihalosilane having the formula R¹₂SiX₂, (iii) at least one tetrahalosilane having the formula SiX₄, (iv) a mixture comprising at least two of (b)(i), (b)(ii), and (b)(iii), and (v) a mixture comprising a monohalosilane having the formula R¹₃SiX and at least one of (b)(i), (b)(ii), and (b)(iii), in the presence of a Lewis acid catalyst to form a polyborosiloxane intermediate, wherein each R¹ is independently C₁ to C₁₀ hydrocarbyl or C₁ to C₁₀ halogen-substituted hydrocarbyl, R² is C₁ to C₈ alkyl, X is —Cl or —Br, the ratio of the sum of the number of moles of (a)(i) and (a)(ii) to the sum of the number of moles of the alkoxyborane (a) and the halosilane (b) is from 0.001 to 0.58, the ratio of the sum of the number of moles of (b)(i), (b)(ii), and (b)(iii) to the sum of the number of moles of the alkoxyborane (a) and the halosilane (b) is from 0.42 to 0.999, the ratio of the number of moles of the halosilane (b) to the number of moles of the alkoxyborane (a) is from 0.724 to 999, and the ratio of the number of moles of the group —X in the halosilane (b) to the number of moles of the group —OR² in the alkoxyborane (a) is at least 1.01;
(II) reacting the polyborosiloxane intermediate and, optionally, at least one halosilane having the formula R¹ₙSiX₄₋ₙ, with water to form a water-insoluble hydrolysis product, wherein R¹ and X are as defined above and n=0, 1, 2, or 3, provided when an excess amount of water is used, the method further comprises separating the hydrolysis product from the water; and
(III) distilling the hydrolysis product to remove water of condensation.

8. The method according to claim 7, wherein the Lewis acid catalyst is iron(III) chloride.

9. The method according to claim 7, wherein the ratio of the sum of the number of moles of (a)(i) and (a)(ii) to the sum of the number of moles of the alkoxyborane (a) and the halosilane (b) is from 0.01 to 0.4.

10. The method according to claim 7, wherein the ratio of the sum of the number of moles of (b)(i), (b)(ii), and (b)(iii) to the sum of the number of moles of the alkoxyborane (a) and the halosilane (b) is from 0.5 to 0.9.

11. The method according to claim 7, wherein the ratio of the number of moles of the halosilane (b) to the number of moles of the alkoxyborane (a) is from 1.2 to 99.

12. The method according to claim 7, wherein the ratio of the number of moles of the group —X in the halosilane (b) to the number of moles of the group —OR² in the alkoxyborane (a) is from 1.2 to 100.

13. The method according to claim 7, wherein the alkoxyborane (a), the halosilane (b), and the optional halosilane (step II) do not contain phenyl groups.

14. The method according to claim 7, wherein at least 10 mol % of the groups represented by R¹ in the alkoxyborane (a), the halosilane (b), and the optional halosilane (step II) combined are alkenyl.

15. A polyborosiloxane prepared according to the method of claim 7.
